(19) United States
(12) Patent Application Publication
(10) Pub. No.: US 2004/0113419 A1
(43) Pub. Date: Jun. 17, 2004

(54) Multi-panel advertisement display

(76) Inventor: Alberto Silvestri, Wayne, NJ (US)

Correspondence Address: SOFER & HAROUN, LLP, Suite 910, 317 Madison Avenue, New York, NY, 10017, US

(21) Appl. No.: 10/656,865

(22) Filed: Sep. 5, 2003

Related U.S. Application Data
(60) Provisional application No. 60/408,601, filed on Sep. 6, 2002.

(51) Int. Cl. G09F 1/00

(52) U.S. Cl. 283/56

(57) ABSTRACT

The present invention is directed to an advertisement display for placement within a printed publication comprised of a plurality of panels, each of which have at least one edge. A first panel, attached to the printed publication, is coupled to at least one second panel along at least one edge of the first panel, such that the second panel is configured to be folded onto the first panel along the edge.

### RELATED APPLICATIONS

This application is related to and claims the benefit of priority to the earlier filed provisional patent application, Serial No. 60 408,601, filed on Sep. 6, 2002, having the same title.

### FIELD

The present invention relates to a method for displaying advertisements. More specifically, the present invention relates to a method for displaying advertisements in print media form.

### BACKGROUND OF THE INVENTION

As is known, magazines have published various types of advertising inserts. They can be as simple as a page or pages in the magazine, a sample affixed between the pages of a magazine or a post card inserted between two pages. Prior advertisement inserts tend to be small, like a postcard insert, or consist simply of page or pages of the magazine. There exists a need for a new form of advertisement that can better attract consumer attention by being readily distinguishable from the rest of the magazine and at the same time convey all the necessary information about the product or service in a format that is aesthetically pleasing, visually interesting and readily accessible to the reader.

### SUMMARY OF INVENTION

The present invention is a multi-panel advertising display strip that is housed on a full-page or multi-page carrier, such as a magazine insert. In one embodiment the multi-panel advertising display is attached to the binding itself. The multi-panel advertising display comprises of panels folded over each other which can be either permanently affixed or can be designed to be removed from the carrier. Panels are two-sided and can have text and/or images on either or both sides. The multi-panel advertising display is a versatile piece and can be folded in various ways some of which include an arrangement where the panels fold horizontally outward, or an arrangement where the panels fold in a zigzag fashion similar to an accordion, or an arrangement where the panels can be placed vertically and folded up from there.

In this configuration the present invention provides a more aesthetically pleasing and noticeable advertisement display, that is capable of displaying standard advertisements as well as more advanced advertisements such as sequential visualizations and mimicked video. This advertisement display allows the advertiser to present the reader with more complex and interesting advertisements such as storyboards, movie clips and time lines.

To this end, the present invention provides for an advertisement display for placement within a printed publication comprised of a plurality of panels, each of which have at least one edge. A first panel, attached to the printed publication, is coupled to at least one second panel along at least one edge of the first panel, such that the second panel is configured to be folded onto the first panel along the edge.

### BRIEF DESCRIPTION OF THE DRAWINGS

FIG. 1A illustrates one embodiment of the present invention wherein the multi-panel display strip that has 6 panels and is affixed to an insert;

FIGS. 1B-1G illustrate the multi-panel display from FIG. 1A in a fully unfolded position, in one embodiment of the present invention;

FIG. 2A illustrates one embodiment of the present invention wherein the multi-panel display strip uses four panels and is affixed to an insert;

FIGS. 2B-2D illustrate the layout of the multi-panel display fully unfolded from FIG. 2A, in accordance with one embodiment of the present invention;

FIG. 3 illustrates one embodiment of the present invention wherein the multi-panel display strip is housed in a multi-page insert;

FIG. 4A illustrates one embodiment of the present invention wherein the multi-panel display strip is affixed so as to unfold vertically;

FIGS. 4B-4E illustrate the unfolded multi-panel display from FIG. 4A, in accordance with one embodiment of the present invention;

FIG. 5A illustrate one embodiment of the present invention wherein the multi-panel display strip folds in an accordion fashion and is affixed to an insert;

FIG. 5B illustrates the unfolded multi-panel display from FIG. 5A in one embodiment of the present invention; and

FIG. 5C illustrates the multi-panel display from FIG. 5A partially folded.

### DESCRIPTION OF INVENTION

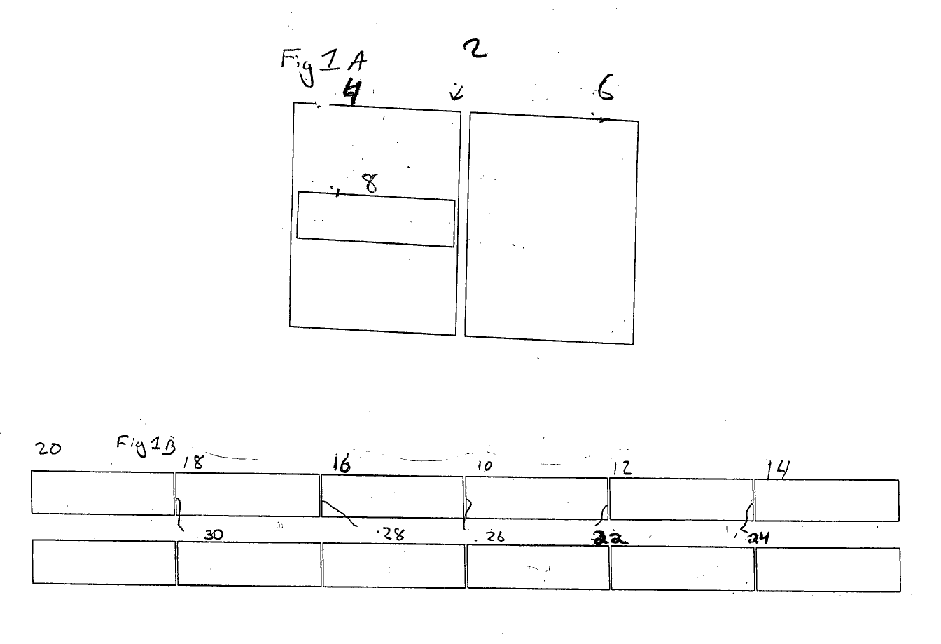

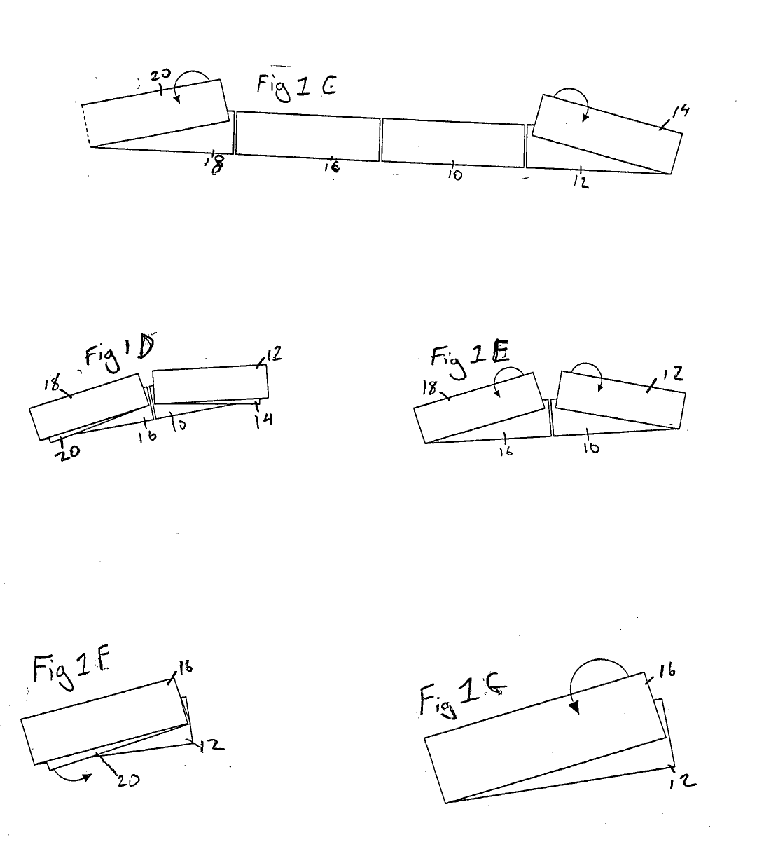

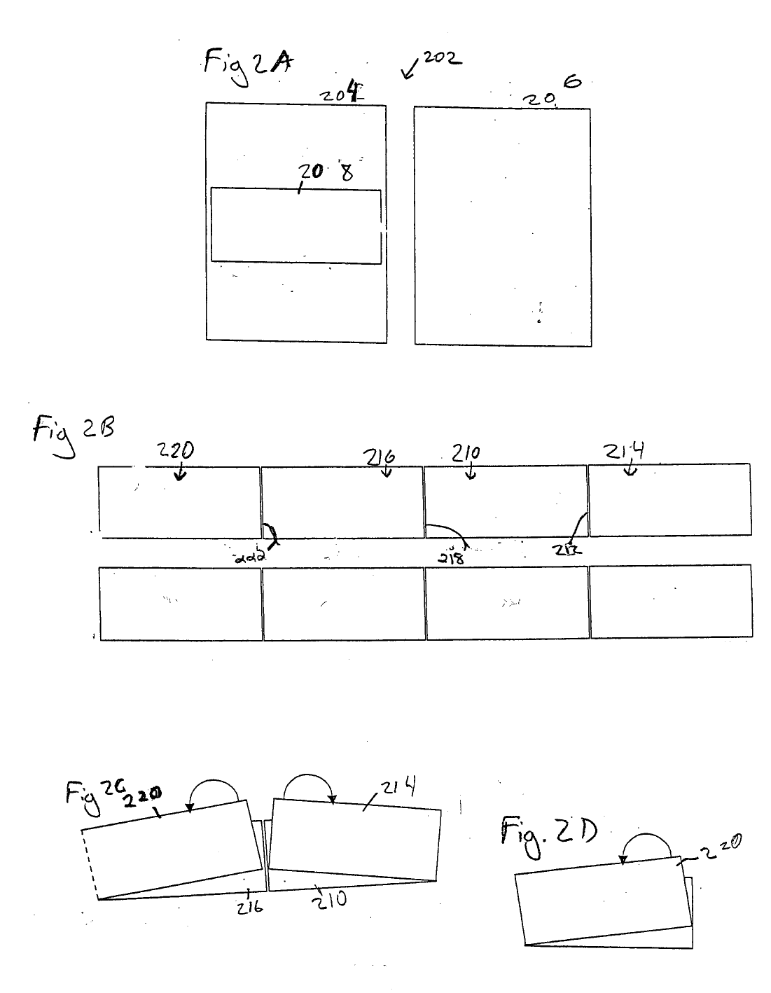

In one embodiment of the present invention, FIG. 1A illustrates a magazine 2, having a left page 4 and a right page 6. A multi-panel advertising display 8, comprised of panels, is positioned so its long edge lays horizontally across the page. An advertising image or content can be printed on advertising display 8. Multi-panel advertising display 8, preferably comprising six panels, is affixed at any desired location in the magazine, in the center of left page 4 as illustrated in FIG. 1A. It should be noted that a multi-panel advertising display having any number of panels is within the contemplation of the present invention, however, a six panel display 8 is used for illustrative purposes.

In one arrangement illustrated in FIGS. 1A through 1G, a panel of advertising display 8 is attached to a page 4 or 6 of magazine 2 where a number of panels are attached panel on either edge for folding out. Multi-panel advertising display 8 folds out to create a longer strip of printing space that can be printed on. Preferably, the width of the panels vertically is substantially 3.5 inches and the length of the panels horizontally can vary from 7.875 inches to 9 inches. It is understood that various other sizes may be used in differently sized magazines 2.

In the arrangement illustrated in FIGS. 1A-1G, a first panel 10 is affixed to a page in magazine 2. As seen in FIG. 1B, the layout of multi-panel display 8 is completely unfolded. A second panel 12 is attached to a right vertical edge 22 of panel 10. A third panel 16 is attached to the left vertical edge 26 of a panel 10. A fourth panel 14 is located on a right vertical edge 24 of second panel 12. A fifth panel 18 is located on the left vertical edge 28 of third panel 16. A sixth panel 20 is attached to a left vertical edge 30 of fifth panel 18.

As illustrated in FIG. 1C, fourth panel 14 folds to the left at the point of attachment to second panel 12 so as to lay flat on top of second panel 12, the front of fourth panel 14 lays face down touching the front of second panel 12. The backside of fourth panel 14 is exposed. Sixth panel 20 folds to the right at the point of attachment to fifth panel 18 so as to lay flat on top of fifth panel 18. The front side of sixth panel 20 faces downward and is laying flat on the front side of fifth panel 18, so that the backside of sixth panel 20 is exposed and the front side of both sixth panel 20 and fifth panel 18 cannot be viewed.

With fourth panel 14 laying flat on top of second panel 12 they both together fold to the left so that both panels 12 and 14 lay flat on top of first panel 10, so that the backside of fourth panel 14 is laying flat on the front side of first panel 10 and the backside of second panel 12 is exposed, as illustrated in FIGS. 1D and 1E. With sixth panel 20 laying flat on top of fifth panel 18 they both fold to the right so as to lay flat on top of third panel 16 so that the front side of sixth panel 20 is laying flat on top of the front side of third panel 16 and the backside of fifth panel 18 is exposed as illustrated in FIGS. 1D and 1E.

As illustrated in FIGS. 1F and 1G, third panel 16 with panels 18 and 20 laying on top of it then folds to the right so it lays flat on top of panels 14, 12 and 10. The backside of third panel 16 functions as a cover when the panels are folded as illustrated in FIG. 1G.

In accordance with one embodiment of the invention, sixth panel 20 and fourth panel 14, are each slightly shorter than fifth panel 18 and second panel 12, and in turn second panel 12 is slightly shorter than panel 10 and fifth panel 18 is slightly shorter than third panel 16. Likewise third panel 16 is slightly shorter than first panel 10 Such an arrangement where, the last panel that is attached is the shortest, and the longest panel is the panel that is affixed to the page facilitates easier folding of the panels.

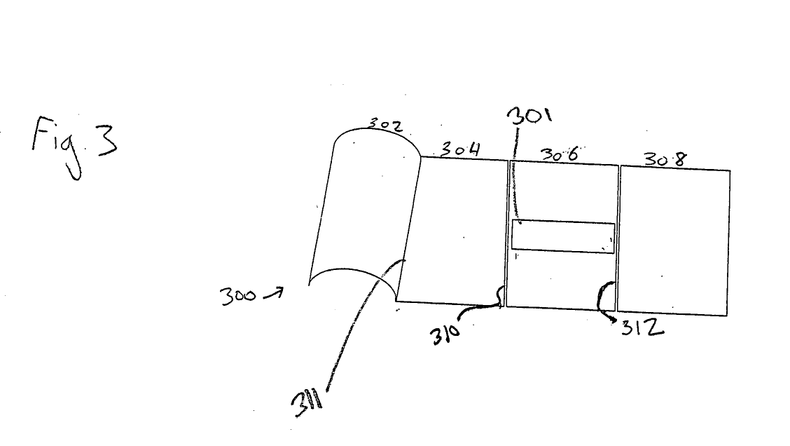

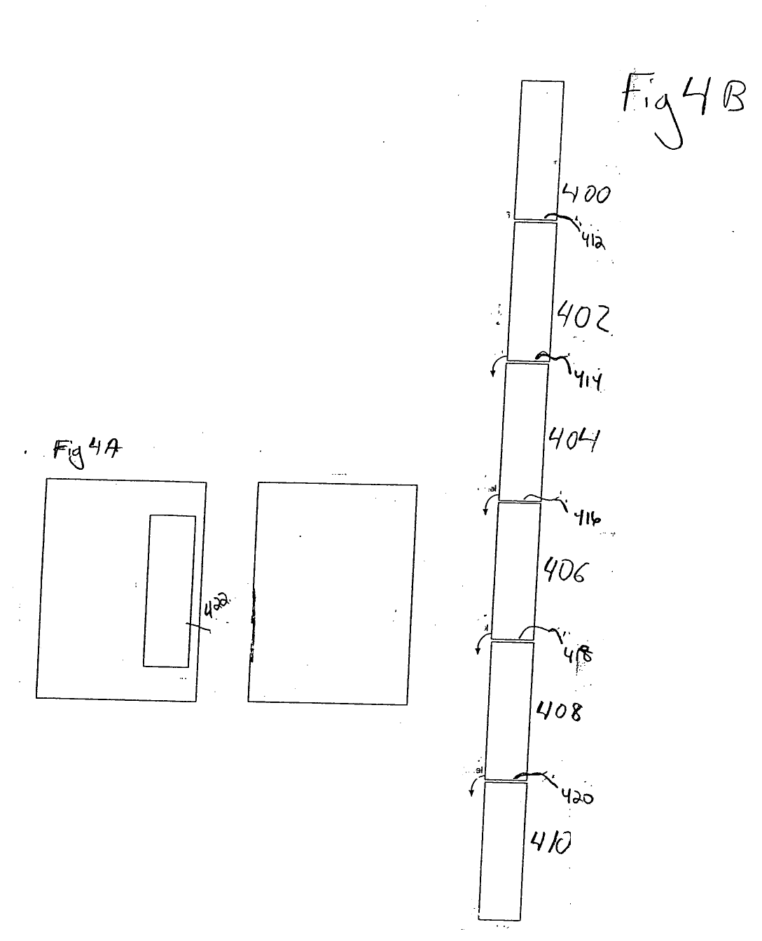

FIG. 2A illustrates another embodiment of the invention wherein a four-sectioned multi-panel display 208 is affixed to a front side of a page 204 of a magazine 202 having a left page 204 and aright page 206. A first panel 210 is attached to page 210. As shown in FIG. 2B, a second panel 214 is attached to a right vertical edge 212 of first panel 210. A third panel 216 is attached to a left vertical edge 218 of first panel 210. A fourth panel 220 is located on a left vertical edge 222 of third panel 216.

As illustrated in FIG. 2C, second panel 214 folds to the left so as to lay flat on top of first panel 210, and fourth panel 220 folds over to the right so as to lay flat on top of third panel 216. Third panel 216 with fourth panel 220 laying on top of it then fold over to the right so as to lay flat on top of panels 214 and 210 as illustrated in FIG. 2D. As illustrated in FIG. 2D, a back side of third panel 218 is exposed and functions as a cover to the panels beneath it. In one embodiment panels 210, 214, 216 and 220 are all substantially 4.5 inches wide. The length of the panels can vary from 7.875 inches to 9 inches. As discussed above, the panels farthest from first panel 210 are the smallest, getting larger as they approach first panel 210.

In either embodiment described in FIGS. 1A-1G and in FIGS. 2A-2D, the panels of advertising display 8 and 208 may have varying patterns of text and images that correlate with their folded arrangements. For example, the completely unfolded display may illustrate a first picture, the partially folded display may present a larger single image and the completely unfolded display may maintain yet another complete different image or even a series of images. The combinations of panels offer and large number of variations allowing different artistic combinations of pictures, images and text that are to numerous to describe in detail. However, any similar advertising display 8 or 208, utilizing a similar folding paper arrangement is within the contemplation of the present invention.

In another embodiment of the invention, the multi-panel advertising display 301 can be part of a multi-page magazine insert 300, as illustrated in FIG. 3A. Multi-page insert 300 comprises pages that fold out in a similar fashion to a multi-panel display 301, but they are larger in size. This is done by attaching a third page 306 to a vertical side 310 of a right magazine page 304 that is attached to the binding 311. The multi-panel advertisement display 301 can then be attached to one of the insert's pages. In FIG. 3A, pages 302 and 304 are left and right pages of a magazine respectively. Third page 306 is attached to right vertical edge 310 of right page 304. Attached to a right vertical edge 312 of third page 306 is a fourth page 308. Fourth page 308 folds to the left, so as to lay flat on top of third page 306. With fourth page 308 laying on top of it, third page 306 folds to the right and lays on top of right page 304. With all the pages folded, the back of third page 306 functions as a cover for pages 304 and 308, and the back of third page 306 is displayed. Located on third page 306 is six sectioned multi-panel advertising display 301 similar to that illustrated and described above in conjunction with FIGS. 1A and 1B.

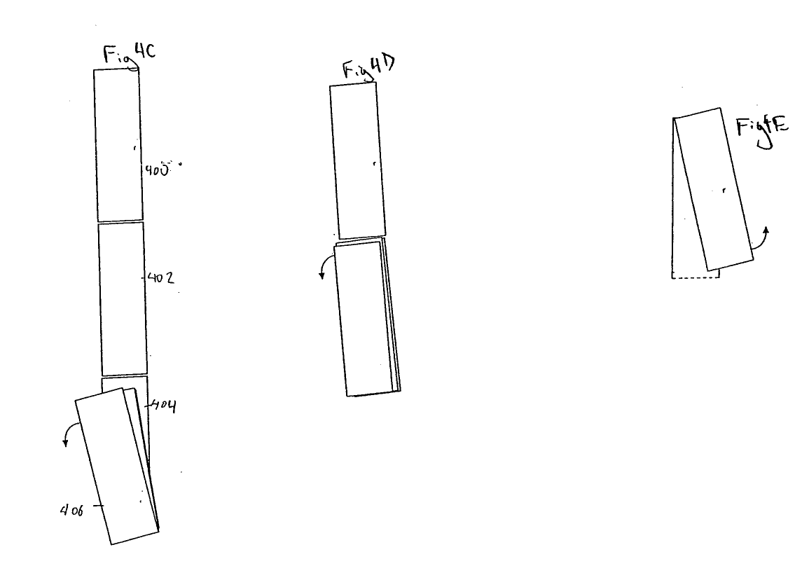

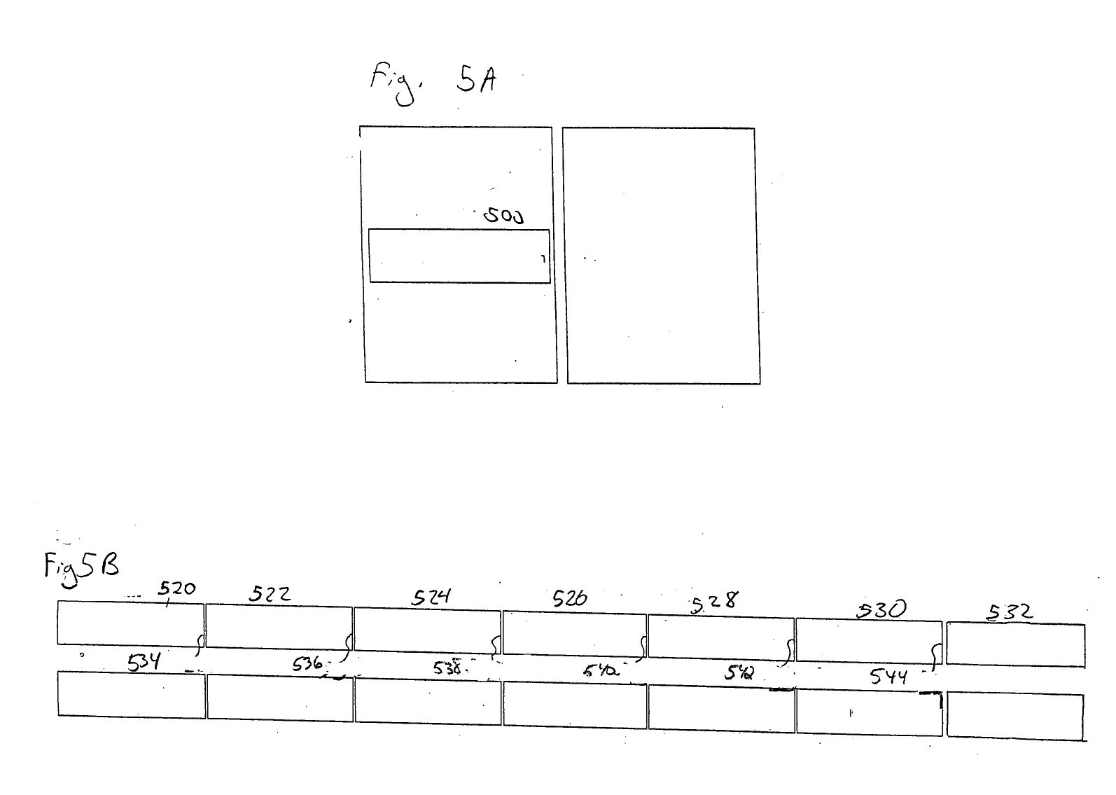

In another embodiment of the invention, the panels of advertising display 422 are placed so that the longer side of the panels are placed vertically. In this arrangement, FIG. 4A illustrates vertical multi-panel advertisement display 422 unfolded. A first panel 400 is affixed to a magazine page. A second panel 402 is attached to a short bottom horizontal edge 412 of first panel 400. Panels 400 and 402 are of approximately the same length. A third panel 404 is attached to a lower vertical edge 414 of second panel 402. Third panel 404 is substantially 5/16 of an inch shorter than panels 400 and 402. Likewise third panel 404 has attached to it a fourth panel 406 on a lower vertical edge 416. Fourth panel 406 is in turn substantially 5/16 of an inch shorter than third panel 404. Fourth panel 406 has attached to a lower edge 418 a fifth panel 408. Fifth panel 408 is substantially 5/16 of an inch shorter than fourth panel 406. A sixth panel 410 is attached to a lower vertical edge 420 of fifth panel 408. Sixth panel 410 is in turn substantially 5/16 of an inch shorter than fifth panel 408.

As illustrated in FIG. 4C, sixth panel 410 folds up so as to lay flat on top of fifth panel 408. Fifth panel 408 with sixth panel 410 laying on top of it, folds upward so that they both lay flat on top of fourth panel 406. Likewise, panels 406, 408, and 410 then fold upward so as to lay flat on top of third panel 404. As illustrated in FIG. 4D, panels 404, 406, 408 and 410 then fold up so as to lay flat on top of second panel 402. As illustrated in FIG. 4E, panels 402, 404, 406, 408, and 410 altogether fold upwards so that they all lay on top of first panel 400. When multi-panel display 422 is completely folded up, the back side of second panel 402 functions as the cover to all the other panels. As with the previous embodiments it is contemplated that, each successive panel from first panel 400 gets shorter, so as to lay flat when folded up. The panels can either attach to the top or bottom short horizontal side of the first panel.

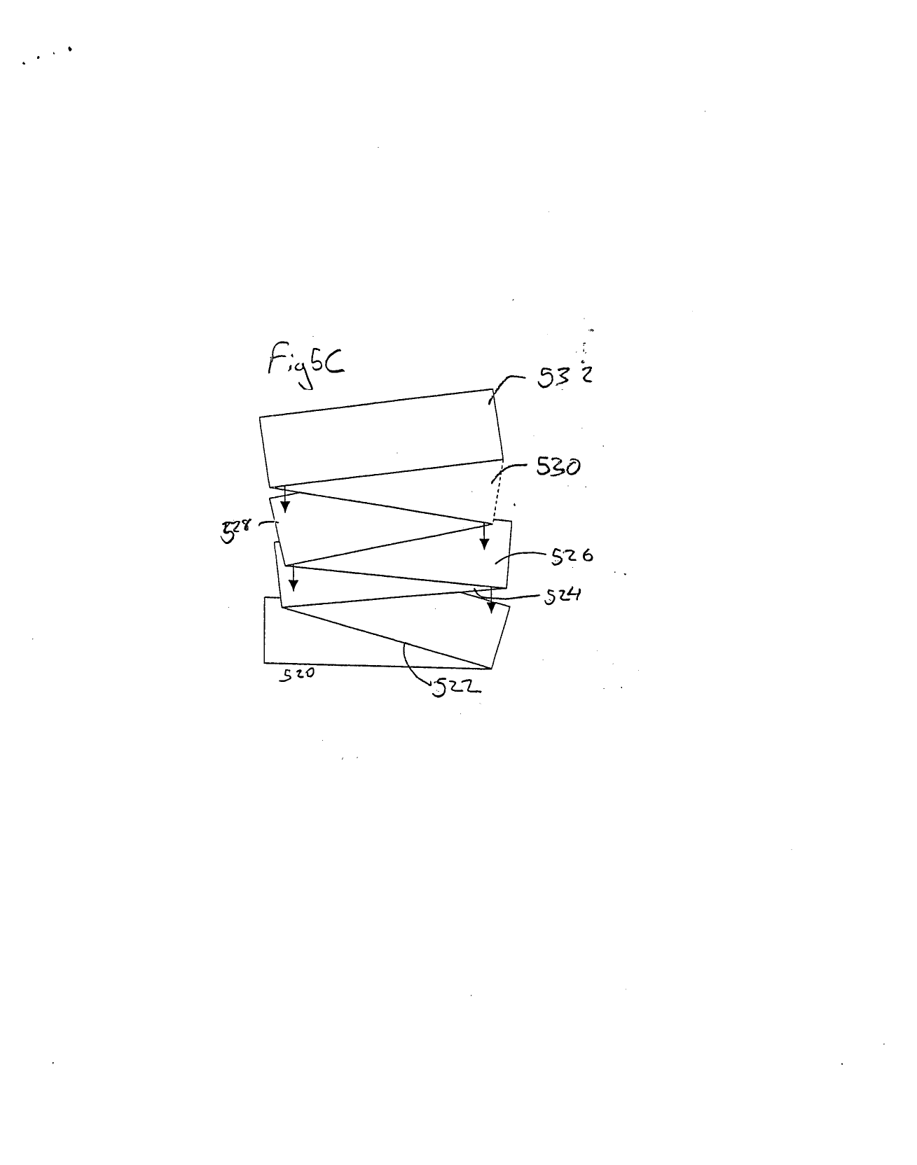

In another embodiment of the invention, shown in FIG. 5A, panels can attach to only one of the vertical sides of the panel that is affixed to the insert page so as to fold out in an accordion like fashion. In this arrangement the panels may be constructed in the same size, because they can still lay flat due to the accordion folding style.

FIG. 5A illustrates an advertisement display 500 attached to page insert which is later bound into a magazine. As shown in FIG. 5A, a first panel 520 of display 500 is affixed to a page in the magazine. As illustrated in FIG. 5B, a second panel 522 is attached on a right vertical edge 534 to first panel 520. A third panel 524 is attached to second panel 522 at a right vertical edge 536. A fourth panel 526 is attached to a right vertical edge 538 of third panel 524. A fifth panel 528 is attached to fourth panel 526 at a right vertical edge 540. A sixth panel 530 is attached to fifth panel 528 at a right vertical side 542. A seventh panel 532 is attached to a right vertical side 544 of sixth panel 530.

FIG. 5C illustrates, the accordion folding multi-panel display 500 partially folded. When in this configuration, second panel 522 folds towards the left so as to lay flat on top of first panel 520. Third panel 524 is attached to the opposite vertical edge of second panel 522 from first panel 520. After second panel 522 has folded on top of first panel 520, third panel 524 is folded towards the right so as to lay flat on top of panels 520 and 522. Fourth panel 526 is folded down to the left so as to lay flat on top of panels 524, 522 and 520. Fifth panel 528 is folded to the right so as to lay flat on top of panels 526, 524, 522 and 520. Sixth panel 530 is folded to the left so as to lay flat on top of panels 528, 526, 524, 522, and 520. Seventh panel 532 is folded to the right so as to lay flat on top of panel 530, 528, 526, 524, 522 and 520. The back side of seventh panel 532 functions as the cover for advertising display 500.

As described above, it is contemplated that in the various configuration of the multi-panel advertising display may contain various prints on the panels that mesh into the print that is placed on the insert below the panels, so that when viewed by a person they could see the full image or content of the advertisement when the panels are folded on top of each other. Panels, when folded out, can convey more information or extend the content on the insert. For example, the image on the insert can be of a woman's face, placed over her eyes is a multi-panel display. When the display is completely folded the image of the full face can be viewed, because the panel that is functioning as a cover to all the others has the image of the woman's eyes and other features covered by the multi-panel display are revealed. In another embodiment the multi-panel display can mesh into the image at every stage of folding, each panel can contain an image that will mesh into the image on the insert.

In each embodiment of the present invention illustrated in FIGS. 1-5, a multi-panel advertising display is placed inside of magazine on a particular page. It is within the contemplation of the present invention that a particularly advantageous means of sequential displays can be provided in conjunction with the image on the page of the magazine on which multi-panel advertising display is placed.

For example, using advertising display 8 from FIGS. 1A-1G as examples, left page 4 and right page 6 of magazine 2 each maintain images of a woman's face, having a particular makeup design for their eyes. When the page is initially opened the woman on right page 6 is viewed having the first set of eyes printed on the page itself, whereas the woman on left page 4, whose face is printed on page 4, is viewed with the set of eyes printed on the back side of third panel 16, which is on top when advertise display 8 is closed.

Upon unfolding the various sets of eyes for the woman on pages 4 and 6 of the magazine 2 are viewed with varying sets of eyes, printed on the alternating front and back sides of the panels of advertising display 8, so that an entire series of eye makeup may be viewed using the same head shot of the model. As display 8 is unfolded to the left and right the different panels line up with the images printed directly on pages 4 and 6. Such an advertising method constitutes a significant improvement over prior art advertising methods as it helps to illustrate the level of difference a particular makeup can have when applied to the same page. It is contemplated that such a method can be used with each of the embodiments of the present invention, in conjunction with the images printed directly on the magazine pages so as to show the varied effects of different, make ups, clothes, hair styles and other elements of fashion.

It is further noted that the advertising display 8, is not limited to fashion designs but may be used in conjunction with any magazine, showing altered modifications to cars, home decorations or any such topics covered by printed publications. Any use of such a multi-panel advertisement display using similar elements to those described herein is within the contemplation of the present invention.

In one embodiment of the invention the panel is constructed of two-ply material. The material can have information on one side while the other side is adhered to the second ply of material. The panels can be affixed to the magazine or insert by any known method such as glue, direct binding or any other manner typically employed in print magazines.

In another embodiment of the invention, the construction of the invention is such that at the point where the panels connect to each other there can be placed a multi-function perforation. The perforation may be configured such that the entire display may be removed from the binding. Alternatively, the perforation may be configured such that the panels can be removed easily from one another. For example, the each separated panel can be a business card, a sample of the product, a coupon, a mailer to be filled out and sent back, or a list of store locations. The perforation may be configured such that the entire display may be removed from the binding.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An advertisement display for placement within a printed publication, said display comprising:
a plurality of panels, each of said panels having at least one edge thereon, wherein a first panel, among said plurality of panels and attached to said printed publication, is coupled to at least one second panel among said plurality of panels along at least one edge of said first panel, such that said second panel is configured to be folded onto said first panel along said edge.

2. The advertisement display as claimed in claim 1, further comprising a third panel coupled to at least one edge of said second panel, wherein said third panel is configured to be folded onto said second panel before said second panel is folded onto said first panel.

3. The advertisement display as claimed in claim 1, further comprising a fourth panel coupled to a second edge of said first panel, wherein said fourth panel is configured to be folded onto said first panel before said second panel is folded onto said first panel.

5. The advertisement display as claimed in claim 1, wherein the coupling between said panels is formed along a solidly formed edge.

6. The advertisement display as claimed in claim 1, wherein the coupling between said panels is formed along a perforated edge.

7. The advertisement display as claimed in claim 6, wherein said panels contain individual advertisements designed to be removed independently from one another.

8. The advertisement display as claimed in claim 7, wherein said individual advertisement designs are any one of coupons, business cards, product samples, a mailer for return mailing, and a list of store locations.

9. The advertisement display as claimed in claim 1, wherein said panels are constructed of a two-ply material forming first and second sides of each panel, such that each side of said panels displays different advertising material.

10. The advertisement display as claimed in claim 1, wherein said first and second panels each maintain images, that when combined, form a larger single image.

11. The advertisement display as claimed in claim 9, where said second sides of said first and second panels each maintain separate images, such that when said first and second panels are folded said second sides of said panels combine to form a larger single image.

12. An advertisement display for placement within a printed publication, said display comprising:
a plurality of pages with at least one page having an image displayed thereon; and
a plurality of panels, each of said panels having at least one edge thereon, wherein a first panel, among said plurality of panels, and attached to said page with a printed image thereon, is coupled to at least one second panel among said plurality of panels along at least one edge of said first panel, such that said second panel is configured to be folded onto said first panel along said edge, and wherein said first and second panels further having images thereon that correspond to the image printed on said page.

13. The advertisement display as claimed in claim 12, wherein when said printed panels are folded over the image on said page, said image on said page is altered.

14. The advertisement display as claimed in claim 12, wherein when said printed panels are folded over the image on said page, said image on said page remains the same.

15. The advertisement display as claimed in claim 12, further comprising a third panel coupled to at least one edge of said second panel, wherein said third panel is configured to be folded onto said second panel before said second panel is folded onto said first panel.

16. The advertisement display as claimed in claim 12, further comprising a fourth panel coupled to a second edge of said first panel, wherein said fourth panel is configured to be folded onto said first panel before said second panel is folded onto said first panel.

17. The advertisement display as claimed in claim 12, wherein the coupling between said panels is formed along a solidly formed edge.

18. The advertisement display as claimed in claim 12, wherein the coupling between said panels is formed along a perforated edge.

19. The advertisement display as claimed in claim 12, wherein said panels contain individual advertisements designed to be removed independently from one another.

20. The advertisement display as claimed in claim 19, wherein said individual advertisement designs are any one of coupons, business cards, product samples, a mailer for return mailing, and a list of store locations.
